(19) United States
(12) Patent Application Publication
(10) Pub. No.: US 2018/0056504 A1
(43) Pub. Date: Mar. 1, 2018

(54) TEACHING APPARATUS FOR MANIPULATOR

(71) Applicant: INDUSTRIAL TECHNOLOGY RESEARCH INSTITUTE, Hsinchu (TW)

(72) Inventors: Chun-Chien Ting, Hsinchu (TW); Jan-Hao Chen, Hsinchu (TW); Teng-Mao Wang, Hsinchu (TW); Chung-Hsien Wu, Hsinchu (TW)

(21) Appl. No.: 15/372,618

(22) Filed: Dec. 8, 2016

(30) Foreign Application Priority Data
Aug. 25, 2016 (TW) 105127233

(51) Int. Cl. B25J 9/00; B25J 13/08

(52) U.S. Cl. CPC B25J 9/0081; Y10S 901/04; B25J 13/085

(57) ABSTRACT

A teaching apparatus for a manipulator is provided, including: a fixing member for fixing to the manipulator; a main body connected to the fixing member; and a handle connected to the main body. The main body includes a plurality of sensors and an operation display member, wherein at least one of the sensors is disposed on one side of the main body adjacent the fixing member and configured for sensing a force, a stress or a torque applied to the main body, and the operation display member is disposed on the other side of the main body and includes a plurality of function keys and a display screen disposed thereon. The teaching apparatus allows the path-teaching process for a manipulator to be completed quickly and easily.

### CROSS-REFERENCE TO RELATED APPLICATION

The present disclosure is based on, and claims priority from, Taiwan Application Number 105127233, filed Aug. 25, 2016, the disclosure of which is hereby incorporated by reference herein in its entirety.

### BACKGROUND

### 1. Technical Field

The present disclosure relates to a teaching apparatus, and, more particularly, to a teaching apparatus for teaching a manipulator a moving path.

### 2. Description of Related Art

Nowadays, the automated factory employs a variety of manipulators. In spite of the stable function and effect brought by the manipulator, the problem very likely to be encountered, when introducing and planning new operation for the manipulator in the beginning, is a slow process and difficulties in error correction. Accordingly, how to quickly guide or teach for generation a correct moving path or numeral program is the key of the introduction.

Therefore, there is an urgent need for a teaching apparatus for a manipulator, allowing the path-teaching process to be completed quickly and easily.

### SUMMARY

The present disclosure provides a teaching apparatus for a manipulator or a robot, including a fixing member for fixture to the manipulator; a main body connected to the fixing member; and a handle connected to the main body. The main body includes a plurality of sensors and an operation display member, wherein at least one of the sensors is disposed on one side of the main body adjacent the fixing member and configured for sensing a force, a stress or a torque applied to the main body, and the operation display member is disposed on the other side of the main body and includes a plurality of function keys and a display screen disposed thereon.

### BRIEF DESCRIPTION OF DRAWINGS

The disclosure can be more fully understood by reading the following detailed description of the embodiments, with reference made to the accompanying drawings, wherein:

FIG. 1 is a schematic diagram illustrating an implementing disposition of a teaching apparatus for a manipulator according to the present disclosure;

FIGS. 2a and 2b are a top view and a front view of the teaching apparatus, respectively; and

FIG. 3 is a flow chart illustrating the operation of the teaching apparatus for a manipulator according to the present disclosure.

### DETAILED DESCRIPTION

In the following detailed description, for the purpose of explanation, embodiments or examples are set forth in order to provide a thorough understanding of the technical features of the present disclosure. In addition, the present disclosure is simply exemplified with, but not limited to, members and disposing methods of specific examples described below.

It shall be understood that for each step of methods in each of the examples, an additional step can be added before, after or in the middle of the steps. Also, some of the aforesaid steps can be replaced, deleted or removed.

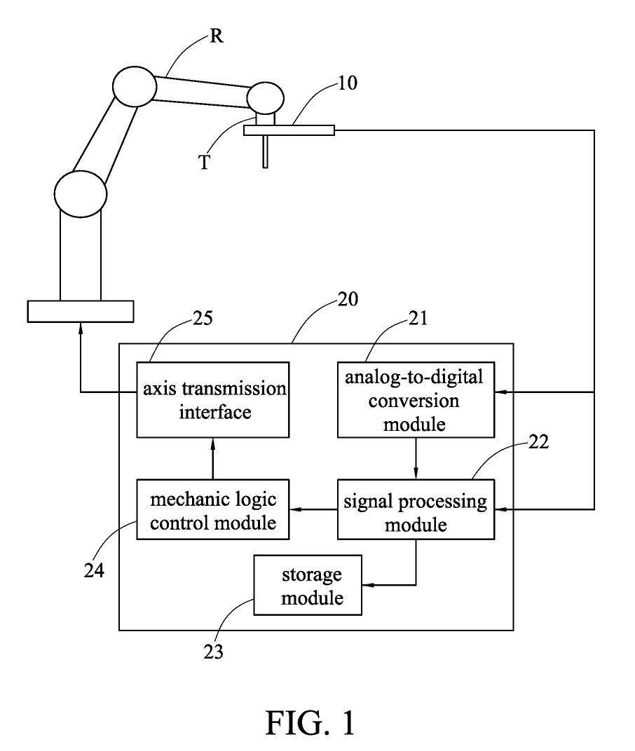

FIG. 1 is a schematic diagram illustrating an implementing disposition of a teaching apparatus 10 for a manipulator R according to the present disclosure. FIG. 1 shows that the teaching apparatus 10 is disposed on a clamping end T of the manipulator R, and is configured for teaching the manipulator R a new moving path for processing and assembling processes, e.g., soldering and picking an object. The manipulator R includes a plurality of coordinate systems such as a coordinate system of a base, each of joints and the clamping end T. Currently, a teaching staff in the art is taught to hold the clamping end T in one hand, and operate a panel with the other hand to switch and enable each of the coordinate systems by the keys thereon. Therefore, only an experienced staff is competent for these works. However, it is time-consuming, and errors occur, too.

The teaching apparatus 10, after being disposed as shown in FIG. 1, is to be electrically connected to a controller 20 of the manipulator R. The controller 20 includes an analog-to-digital conversion module 21, a signal processing module 22, a storage module 23, a mechanic logic control module (MLC) 24, and an axis transmission interface 25 or a multi-axis exercise control module. Signals and instructions of the teaching apparatus 10 are converted and processed by the analog-to-digital conversion module 21 and the signal processing module 22, respectively, to drive the manipulator R to move in each dimension of each coordinate system, and paths and positions are recorded in the storage module 23.

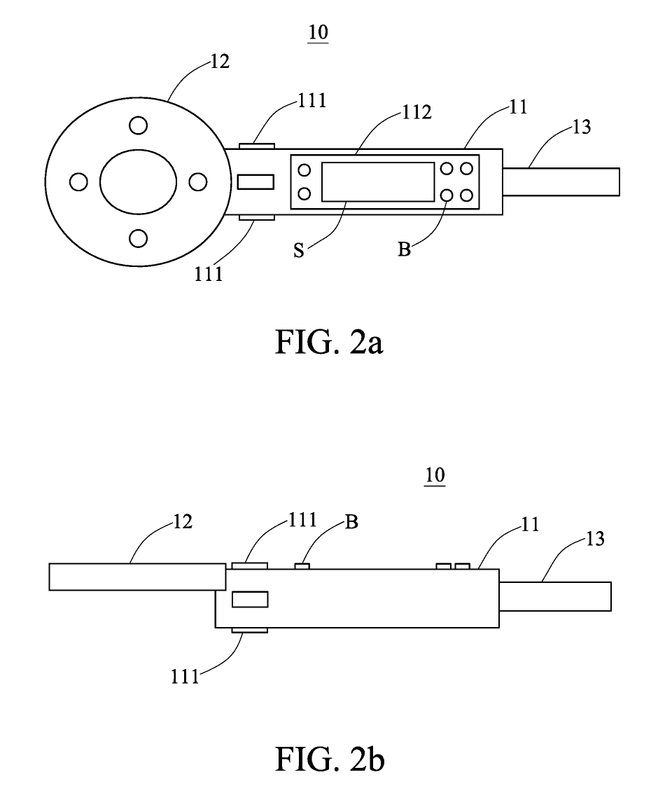

FIGS. 2a and 2b are a top view and a front view of the teaching apparatus 10 of the present disclosure, respectively. These two figures illustrate the teaching apparatus 10 in detail, including, e.g., a fixing member 12, a main body 11 and a handle 13, and these three can be disposed in one, or locked together. The fixing member 12 has a locking hole for being mounted to the clamping end T of the manipulator R. As shown in FIG. 2a, although the fixing member 12 is in shape of disc, the shape thereof can be changed, depending on an actual shape of the clamping end T. The main body 11 is connected to the fixing member 12, and a plurality of sensors 111, e.g., force, stress or torque sensors, are disposed adjacent to or on one side of the fixing member 12, surrounding the main body 11 with a same angle or a same interval so as to sense a pulling force, pressure, stress or torque applied to the one side of the main body 11 from each direction. An operation display member 112 is disposed on the other side of the main body 11. The operation display member 112 includes a plurality of function keys B and a display screen S, respectively, for inputting data, enabling a controller, and displaying positions and coordinate systems. In addition to the displaying function, the display screen S also provides a light signal, with different colors or frequencies, to remind the teaching staff of the current positions and coordinate systems.

FIGS. 2a and 2b also show a handle 13 that is locked to the main body 11. The teaching staff holds the handle 13 in a hand, pushing and pulling the manipulator R. Also, a coordination with the sensors 111 and the function keys B timely actuates or enables the controller 20 to drive each dimension of each coordinate system. As such, a resistance applied to the teaching staff when pushing or pulling the manipulator R is reduced, so as to quickly and easily complete the path-teaching process.

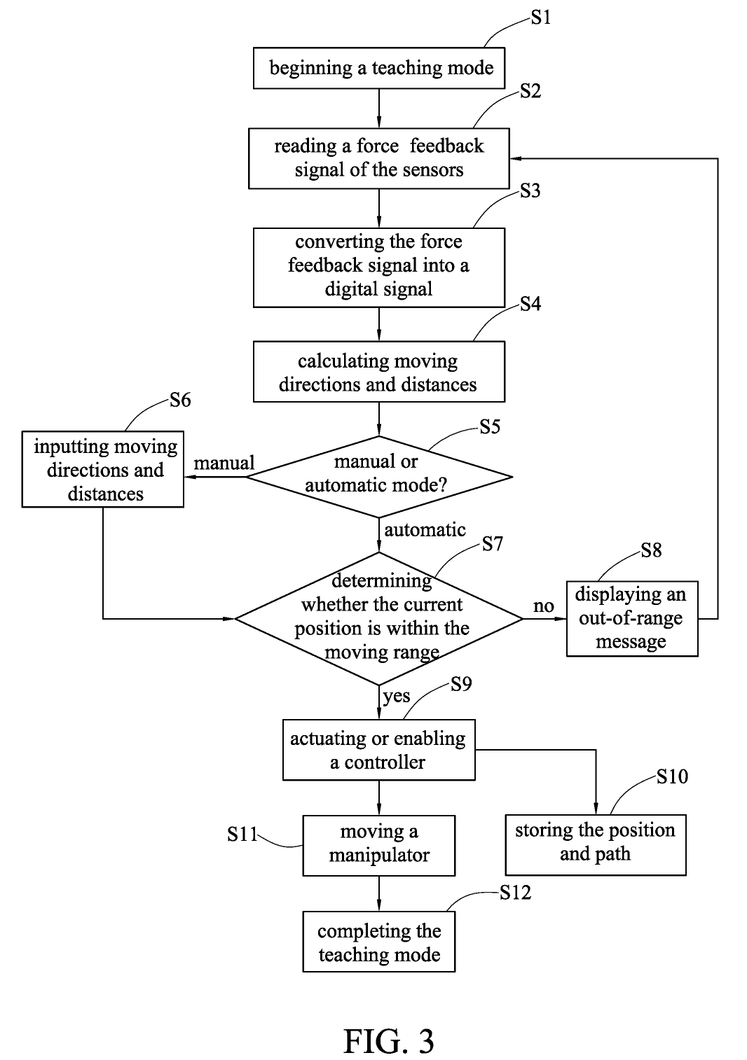

FIG. 3 is a flow chart illustrating the operation of the teaching apparatus 10 coordinated with the controller 20 of the manipulator R. As shown in step S1, when a teaching mode begins, a plurality of the sensors 111 on the main body 11 sense a force feedback signal applied to the main body 11, as shown in step S2, from the teaching staff through the handle 13. The force feedback signal is, as shown in step S3, transmitted to the analog-to-digital conversion module 21 of the controller 20, and is converted by the analog-to-digital conversion module 21 to be a digital signal before further transmitting to the signal processing module 22. The force feedback signal represents the moving path, by the teaching staff operating the clamping end T of the manipulator R, in each dimension of the coordinate system. However, a complete manipulator operation path must also include the moving path of coordinate systems for the joints and base in each dimension thereof. As such, by operating the function keys B of the operation display member 112, the teaching staff can switch to different coordinate systems, enabling or actuating the controller 20 for the driving in each dimension thereof, so as to easily push and pull the manipulator R. As shown in step S4 and FIG. 1, these switching, actuating or enabling commands are transmitted directly from the operation display member 112 to the signal processing module 22, and are processed together with the force feedback signals.

As shown in step S4, when the signal processing module 22 receives the force feedback signal and the switching commands of the function keys B, a conversion of positions and coordinate systems in each dimension is performed to calculate directions and distances needed for the moving. Then, if it is under the condition of an automatic mode and a current position within the moving range at that time, as shown in steps S5 and S7, the signal processing module 22 would transmit, through the axis transmission interface 25, calculated results and controlling commands to the mechanic logic control module 24, and then to each driving motor (not shown) of the manipulator R. As such, as shown in steps S9 and S11, the controller 20 is actuated or enabled to drive the motors so as to move the manipulator R. Also, as shown in steps S10 and S12, the moving path and positions are stored in the storage module 23 to complete the teaching mode. However, as shown in step S6, when switching to a manual mode, the teaching staff has to press the function keys B, or input moving directions and distances on the display screen S manually. Further, as shown in step S8, if the current position is not within the moving range, the display screen S would display an out-of-range message alert to remind the teaching staff of returning to step S2, in which the force feedback signal is read again for starting another teaching process.

The teaching apparatus 10 according to the present disclosure integrates the sensors 111, and the function keys B and the display screen S of the operation display member 112 in one. In addition to a complete teaching function for the manipulator R, the teaching apparatus 10 also allows the teaching staff to complete the teaching process of the manipulator R quickly and easily with only one hand, avoiding complicated and time-consuming operations.

Therefore, the teaching apparatus for a manipulator according to the present disclosure not only integrates all of the controlling functions needed in one during a teaching process, but also provides a display and alert functions to timely remind the teaching staff, allowing the operation to be completed quickly and easily.

The present disclosure is exemplified with, but not limited to, various examples as described above. Also, it is apparent to one skilled in the art that various modifications and alterations can be made to the disclosed examples without departing from the spirit and scope of the present disclosure. Hence, the examples described above are not used to limit the scope of the present disclosure, which is indicated by the accompanying claims.

What is claimed is:

1. A teaching apparatus for a manipulator, comprising:
a fixing member configured to be fixed to the manipulator; and
a main body connected to the fixing member and comprising a plurality of sensors and an operation display member, wherein at least one of the sensors are disposed on one side of the main body adjacent the fixing member and configured to sense a force, a stress or a torque applied to the main body, and the operation display member is disposed on the other side of the main body and comprises a plurality of function keys and a display screen disposed thereon.

2. The teaching apparatus of claim 1, further comprising a handle connected to the main body.

3. The teaching apparatus of claim 1, wherein the sensors surround the main body with a same angle.

4. The teaching apparatus of claim 1, wherein the sensors surround the main body with a same interval.

5. The teaching apparatus of claim 1, wherein at least one of the sensors is configured to be electrically connected to a controller of the manipulator.

6. The teaching apparatus of claim 5, wherein the operation display member is configured to be electrically connected to the controller of the manipulator.

7. The teaching apparatus of claim 5, wherein at least one of the function keys is configured to actuate the controller.

8. The teaching apparatus of claim 5, wherein at least one of the function keys is configured to enable the controller.

9. The teaching apparatus of claim 1, wherein at least one of the function keys is configured to input data.

10. The teaching apparatus of claim 1, wherein the display screen is configured to display positions of the manipulator at different times.

11. The teaching apparatus of claim 10, wherein the display screen is configured to display the positions of the manipulator with different colors.

12. The teaching apparatus of claim 10, wherein the display screen is configured to display the positions of the manipulator with different frequencies.

13. The teaching apparatus of claim 1, wherein the display screen is configured to display coordinate systems of the manipulator at different times.

14. The teaching apparatus of claim 13, wherein the display screen is configured to display the coordinate systems of the manipulator with different colors.

15. The teaching apparatus of claim 13, wherein the display screen is configured to display the coordinate systems of the manipulator with different frequencies.
